(19) United States
(12) Patent Application Publication
(10) Pub. No.: US 2022/0016518 A1
(43) Pub. Date: Jan. 20, 2022

(54) Confidence Is Boss

(71) Applicant: Sophia L. Burrell, Jamaica, NY (US)

(72) Inventor: Sophia L. Burrell, Jamaica, NY (US)

(21) Appl. No.: 16/932,938

(22) Filed: Jul. 20, 2020

(51) Int. Cl. A63F 9/18; G09B 19/22; A63F 3/00

(52) U.S. Cl. CPC A63F 9/18; A63F 1/02; A63F 3/00176; G09B 19/22

(57) ABSTRACT

“Confidence Is Boss” Board-Game is a personal development tool utilizing the acronym V.I.C.T.O.R.Y. as a constructive and practical guide to personal growth. The “C” in V.I.C.T.O.R.Y. is characterized by confidence. It is the center of attention, the ringleader of all including traits that relays instruction allowing all the traits to feed on it. The board-game is controlled by a set of playing cards, with each player having their own deck of cards which corresponds with the character they chose in the game. Confidence Deck and the Solution Deck are generally accessible to every player, providing instructions, solutions, questions and direction for personal victory.

### BACKGROUND OF THE INVENTION

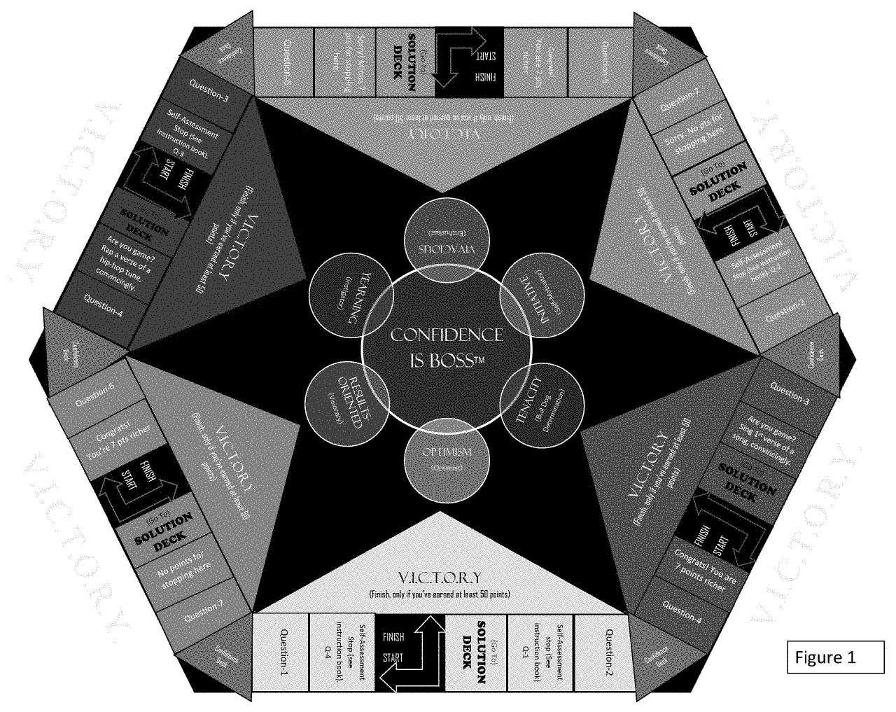

Confidence is Boss is a board game based on the concept of the book titled “7 Traits for V.I.C.T.O.R.Y” (first published in 2012, expanded in 2015), by said inventor and author, Sophia Burrell, where the word victory is used as an acronym comprising seven (7) enduring qualities essential to victory. The “C” in V.I.C.T.O.R.Y. is characterized by confidence. It symbolizes a boss-like character, a ringleader who relays instructions and all the other traits including vivacious, initiative, tenacity, optimism, results-oriented and yearning, feed on it. The board-game (FIG. 1) reveals a radial Venn showing an overlapping relationship between all the including characters.

The field of the art to which the invention pertains is the board game genre. It is a tabletop board-game allowing players to communicate, interact and compete. One known issue that might evolve in this art is that this board-game provides a unique and not yet popular tool in personal development but can eventually be a go-to utility or strategy for personal development, especially for individuals between 14-30 years old.

### SUMMARY OF THE INVENTION

“Confidence is Boss” Board-Game is an inventive concept utilizing the word victory as an acronym that symbolizes seven enduring qualities essential to victory. The “C” in V.I.C.T.O.R.Y. is characterized by confidence. It's the ringleader of all traits and all the other traits feed on it. It is based on this background why confidence is boss.

One main advantage of “Confidence is Boss” is that it is a critical thinking mecca for personal growth. It creatively and strategically boosts and build confidence, help players with their own self-assessment, solution-driven guide for goal setting and achievement, it's a great way to get to know someone and It's a perfect icebreaker. Ideas are generated based on the solution deck set of playing cards. The game drives on the ability to make players feel good themselves and as well, show areas that needs work.

With the overlapping relationship of confidence and all the other traits, including vivacious, initiative, tenacity, optimism, results-oriented and yearning, players will leave the game with a full understanding of the qualities essential to victory and how to utilize these qualities to their advantage.

### BRIEF DESCRIPTION OF THE DRAWINGS

In FIG. 1, a hexagon shaped board game, Confidence is Boss, highlights the overlapping relationship between confidence, initiative, vivacious, tenacity, optimism, results-oriented and yearning.

### DESCRIPTION

Confidence is Boss is a board game based on the concept of the book titled “7 Traits for V.I.C.T.O.R.Y” (first published in 2012, expanded in 2015), by said inventor and author, Sophia Burrell, where the word victory is used as an acronym comprising seven (7) enduring qualities essential to victory. The “C” in V.I.C.T.O.R.Y. is characterized as confidence. It symbolizes a boss-like character, a ringleader who relays instructions and all the other traits (described below) feed on it:

V—Vivacious (i.e. enthusiastic)

I—Initiative (i.e. Self-motivated and Resourceful)

C—Confidence (i.e. Ringleader of all traits, the boss)

T—Tenacity (i.e. Uncompromising with effortful action)

O—Optimism (i.e. Looking at favorable outcomes)

R—Results-oriented (i.e. Knowing what one is playing for)

Y—Yearning (i.e. instigator [desire/hunger/passion] that provokes action).

The board game was developed to further expound the V.I.C.T.O.R.Y. concept and be a personal development tool for self-improvement. Within the concept and the board game, confidence is at the center of attention. Confidence relays instructions and all the other traits feed on it. Confidence is the Boss. For this reason, the board-game has a “Confidence Deck” consisting of eighteen (18) playing cards with instructions or questions relating to building or boosting one's confidence as the player move around the board. There are six blue triangles on the board representing the landing that give players access to the confidence deck. The confidence deck is the blue deck of cards. All six players have access to the confidence deck, albeit, they must land on that spot on the board.

One addition to the concept that enhances how the game is played is the “Solution Deck” consisting of eighteen (18) cards. Each of these provide solutions or at least questions that allows the player to think of a way out. All six players have access to the solution deck, albeit, if they land on the spot designated on the board. The solution deck is a set of black cards.

Generally, each player has their own deck of playing cards, matching the character they chose at the beginning of the game. These decks consist of 7 cards. Orange deck represents the Vivacious Traits. Green deck represents Initiative character. Purple represents Tenacity character. Yellow represents Optimism character. Magenta represents the results-oriented character. Red represents the Yearning character. The individual tokens and each player's deck of cards should match or corresponds with the character/color on the board. The questions on each card relates to the character being played. For example, Initiative deck are questions relating to a self-motivated and resourceful quality. Questions numbered 1-7 are randomly placed on the board and any player who lands on any of those questions must answer the corresponding question/number card in their deck.

No playing cards needed for the performance challenge and the self-assessment stops. The performances include rapping or singing a selected song by the player, big points can be earned for showing courage, pizazz, and confidence in one's ability when placed in the spotlight. The players are responsible for rating the performance as they see fit. Scores are between 1-10 from each player. Another play that doesn't require the use of the playing cards is the self-assessment stops, providing the players with an opportunity for self-reflection/assessment as they play. Four questions are provided in, the instruction booklet, but only one question at a time is to be answered for that block's request.

One standard dice is provided in the game, blue color. This numbered dice 1-6 will indicate the amount of spaces each player will be moving around the board. Each player is allowed one throw per turn. There is only one exception to this rule, which is that if a player reaches the finish line with points amounting to 45+, (50 points is required to finish) they can throw the dice three times to get the number 6 on the dice. Or add up all the numbers from each throw for 6. If the player fails to acquire these points they have to continue around the board. All players are required to continue around, the board if they do not meet the 50-point requirement or the one exception rule.

A player must earn at least 50 points at the finish line to be considered a winner. There are plenty of opportunities around the board to earn those points. If a player gets to the finish line with less than 50 points they must continue around the board, with the exception explained above.

### How the Game is Played:

1. To start, each player must select the character they wish to play. Select the deck corresponding to the character and the token that matches.
2. Throw the dice to determine number of moves to make.
3. No special number is required to start. Players must choose among themselves who is to throw the dice first. Then each player takes their turn to throw the dice.
4. Start at start box.
5. Each player must earn at least 50 points at the end of the trail.
6. If two or more players land on the same spot on the board, points/play will not be affected.
7. Questions 1-7 on the board relates to the deck each player has selected.
8. These numbered questions should be answered from each player's own deck no matter where on the board the questions are.
9. Solution and confidence decks are for every player. Any player who lands on those spots must pick a card from the respective deck and respond to questions/instructions. Return cards to the bottom of the deck when done.
10. The player with the highest points at the finish point wins. Victory dances are allowed:)

### Points Structure:

Solution deck cards are 6 points each.

Self-assessment stops are 6 points.

Confidence deck cards are 8 points.

Each player must keep track of their own points throughout the game.

Questions 1-7 are 4 points each.

Rap/Sing (Players judge performance). Add pts from players scoring 1-10 pts.

### Self-Assessment Stops:

If a player lands on these spots on the board, the following questions much be answered:

Q1. Three adjectives describing who you are.

Q2. If you could be a better person, what would you change?

Q3. In assessing where you are in life, name two things you are struggling with.

Q4. Name two things which in your view have accurately built your identity.

### Conundrum Battle Showdown

Sometimes the player who finishes first is not the player with the highest point. This creates a dilemma, that pushes the game to the next level. As such, the player with the highest point and the player who finished first will have to battle it out for ultimate victory. Six cards are specifically created for this battle. Each player will pick a card and, the answer is judged by the players who just lost the game thereby determining which response is more worthy for the highest score. Answers must be graded according to how funny, intellectually savvy, accurate or relatable they are.

1. Confidence is Boss is a hexagon-shaped board-game utilizing the V.I.C.T.O.R.Y. acronym comprising seven (7) qualities essential to victory, where “C” is characterized by confidence, and the board-game including;
ELEMENT 1
the “V” in V.I.C.T.O.R.Y. is characterized by Vivacious, and represents an orange color set of playing cards marked with seven questions relating to this character only accessible with questions 1-7 on the board;
ELEMENT 2
the “I” in V.I.C.T.O.R.Y. is characterized by Initiative, and represents a green color set of playing cards marked with seven questions relating to this character only accessible with questions 1-7 on the board;
ELEMENT 3
the “C” in V.I.C.T.O.R.Y. is characterized by Confidence and represents a blue color set of playing cards marked with eighteen (18) instructions and strategies to build and boost of this character, only accessible at point of reference “confidence deck” on the board;
ELEMENT 4
the “T” in V.I.C.T.O.R.Y. is characterized by Tenacity and represents a purple color set of playing cards marked with seven questions relating to this character, only accessible with questions 1-7 on the board;
ELEMENT 5
the “O” in V.I.C.T.O.R.Y. is characterized by Optimism, and represents a yellow color set of playing cards marked with seven questions relating to this character, only accessible with questions 1-7 on the board;
ELEMENT 6
the “R” in V.I.C.T.O.R.Y. is characterized by Results-Oriented, and represents a magenta color set of playing cards marked with seven questions relating to this character, only accessible with questions 1-7 on the board;
ELEMENT 7
the “Y” in V.I.C.T.O.R.Y. is characterized by Yearning, and represents a red color set of playing cards marked with seven questions relating to this character accessible with questions 1-7 on the board;
ELEMENT 8
a Solution Deck comprising a set of playing cards marked with eighteen instructions and solution-driven strategies relating to goal setting, advancement and ideas for change, only accessible at point of reference “solution deck” on the board;
ELEMENT 9
a Conundrum Battle showdown, second level of the board-game that determines who achieves ultimate victory, represents a set of playing cards marked with six thought provoking questions that can be life changing or revealing;
ELEMENT 10
a Hexagon-shaped board-game with each side representing a character from the V.I.C.T.O.R.Y. acronym and accommodating six blocks/spaces on each side (36 total) plus six blue confidence triangle that sits at the inside corner of every angle, making the total moves/spaces around the board to be forty-two (42);
ELEMENT 11
a colorful array of the board-game (orange, green, purple, magenta, red, yellow and blue) makes a black six-star prominent at center, each point cleverly touching confidence's triangle that is sitting at every corner of the hexagon;
ELEMENT 12
at the board's center, within the 6-star, and the point from which the design began, is a radial Venn showing the overlapping relationship between confidence and the six other traits within the acronym, from the base of every side of the hexagon a triangle arrow points toward this relationship clearly exposing the 6-star;
ELEMENT 13
self-assessment stops are four randomly placed blocks on the board Q1 to Q4, allows for assessing oneself through a selection of four psychologically based questions found on the instruction manual;
ELEMENT 14
start and finish are the same block, no special number on the dice to start, but players need to choose the deck of cards representing the character they wish to play, and to finish (for victory), 50 points is required, if a player earned 45-49 points they have the option of throwing the dice thrice to get 6, or add all numbers from each throw;
ELEMENT 15
you are 7 points richer, are three random blocks around the board that is considered free points, and no points for stopping at various blocks or minus 5 minus for stopping at various blocks on the board; and
ELEMENT 16
a performance element provides two chances for singing or rapping a favorite song, the players are the judge scoring 1-10 points, adding all judges points for the total score.
